(19) United States
(12) Patent Application Publication
(10) Pub. No.: US 2015/0060089 A1
(43) Pub. Date: Mar. 5, 2015

(54) HORSE SHOE

(71) Applicant: FRED E. KUNKLE, NEW RIVER, AZ (US)

(72) Inventor: FRED E. KUNKLE, NEW RIVER, AZ (US)

(21) Appl. No.: 14/010,744

(22) Filed: Aug. 27, 2013

(51) Int. Cl. A01L 1/02

(52) U.S. Cl. CPC A01L 1/02
USPC 168/23

(57) ABSTRACT

A horse shoe is configured to aid in preventing stone bruise. The horse shoe includes a top side that is flat around an outer perimeter and has a concave portion which slopes inward wherein the outer perimeter can permit a nail to enter a hoof at an angle. A bottom side is connected to the top side through the front portion. Nail channels and traction bars formed into the bottom side.

### BACKGROUND

The embodiments herein relate generally to animal husbandry. In particular, embodiments of the disclosed invention relate to horse shoes.

As used in this application, “foot” refers to the hoof and all its internal structures, including bones and sensitive structures. The “hoof” is the hard outside covering of the foot.

Prior art horse shoes are used primarily to prevent excessive wear on hoof walls thereby causing only the walls to support each stride. These horse shoes are designed to support the entire foot using just the outer walls.

To contrast, wild and feral horses use the entire foot for support with shorter toes, thicker soles and hooves with much higher angles, and less leverage with each stride. Embodiments of the disclosed invention are designed for the foot to be trimmed and applied in a manner to aid the shorter toe with added protection and use of the entire hoof for fraction and support the entire hoof rather than just the outside walls of the hoof. This simulates the way that wild horses naturally run better than the common knowledge for use of domesticated horses.

Prior art horse shoes are offered with nail holes placed evenly around the outside rim of the horse shoe. There are no options for nail placement in the event of foot damage due to missing area of hoof wall. In the event the hoof wall may be damaged or missing entirely due to injury, nail holes placed in such a manner around the outer edge of the horse shoe to be installed on the hoof may not have a hoof wall to nail into to maintain the integrity or attach the horse shoe securely on the foot. When prior art horse shoes have nail holes placed around the outer edge of the shoe in such a way, if damage or injury has occurred to the hoof wall, the nail cannot be placed within the white line properly to retain the shoe properly. In some cases, due to the location of the nail holes in current horse shoes, nails may not be placed into the hoof wall whatsoever to retain the shoe properly.

Embodiments of the disclosed invention solve this problem by placing twelve nail channels between traction bars across the entire weight bearing surface of the hoof thereby becoming twelve nailing options where the nail may be placed along the nail channel to place the nail properly within the white line in the event the hoof wall has been damaged due to trauma or injury.

Prior art horse shoes are designed for only the hoof wall to be the bearing surface with each stride. Embodiments of the present invention allows for the entire foot to become the bearing surface by protecting the entire foot as it lands upon the ground, heel first, thus protecting the entire hoof capsule.

Prior art horse shoes are primarily made with little or no traction provided to avoid slipping thereby producing injuries to each of these structures from stress in addition to the excessive leverage because of the overall weight of the horse shoe. The disclosed horse shoe reduces the leverage and weight and provides traction bars with a self-cleaning traction feature that forces dirt and debris from the traction bar area with each landing stride thus enabling the shoe to gain a new purchase of terrain for the next power stride without excessive slipping.

### SUMMARY

A horse shoe is configured to aid in preventing stone bruise. The horse shoe comprises a top side is flat around an outer perimeter and comprises a concave portion which slopes inward wherein the outer perimeter can permit a nail to enter a hoof at an angle. A bottom side is connected to the top side through the front portion. Nail channels and traction bars formed into the bottom side. The traction bars possess a self-cleaning traction feature that forces dirt and debris from the traction bars enabling the horse shoe to gain traction and avoid excessive slipping.

In some embodiments, the channels further comprise a right side central channel which is joined to a plurality of right side connecting channels. The plurality of right side connecting channels extend from inside and outside of the right side central channel. The plurality of left side connecting channels extend from inside and outside of the right side central channel.

### BRIEF DESCRIPTION OF THE FIGURES

The detailed description of some embodiments of the invention is made below with reference to the accompanying figures, wherein like numerals represent corresponding parts of the figures.

FIG. 1 is a bottom perspective view of an embodiment of the invention shown in use.

FIG. 2A is a top perspective view an embodiment of the invention.

FIG. 2B is a section view an embodiment of the invention.

FIG. 3 is a bottom perspective exploded view an embodiment of the invention.

FIG. 4A is a detail section view an embodiment of the invention along line 4-4 in FIG. 1.

FIG. 4B is a detail section view an embodiment of the invention along line 4-4 in FIG. 1.

FIG. 4C is a detail section view an embodiment of the invention along line 4-4 in FIG. 1.

FIG. 4D is a detail section view an embodiment of the invention along line 4-4 in FIG. 1.

FIG. 5 is a general rendition an embodiment of horse hoof anatomy provided for reference.

### DETAILED DESCRIPTION OF CERTAIN EMBODIMENTS

FIG. 5 provides a general rendition of horse anatomy. H: is a horse's hoof includes heel perioplium H1, heel buttress H2, frog H3 with apex of frog H12, central groove H4, collateral groove H5, heel H6, bar H7, seat of corn H8, pigmented walls H9, water line H10, white line H11, the sole H13 and toe H14. One can use the following lines to divide hoof H into quarters H 16: Line H15 indicates how to measure width and line H17 indicates how to measure length.

Sole H13 covers the whole space from white line H11 to frog H3, on the underside of hoof H. Sole H13 has a deep layer has a compact, waxy character and it is called the “live sole.” Its surface is variable in character as a result of ground contact. A stone bruise can affects sole H13. The stone bruise is often caused by a horse treading on a stone or sharp type of object, landings from high jumps and excessive exposure to snow. A major symptom of a stone bruise is lameness. Embodiments of the present invention solve that problem.

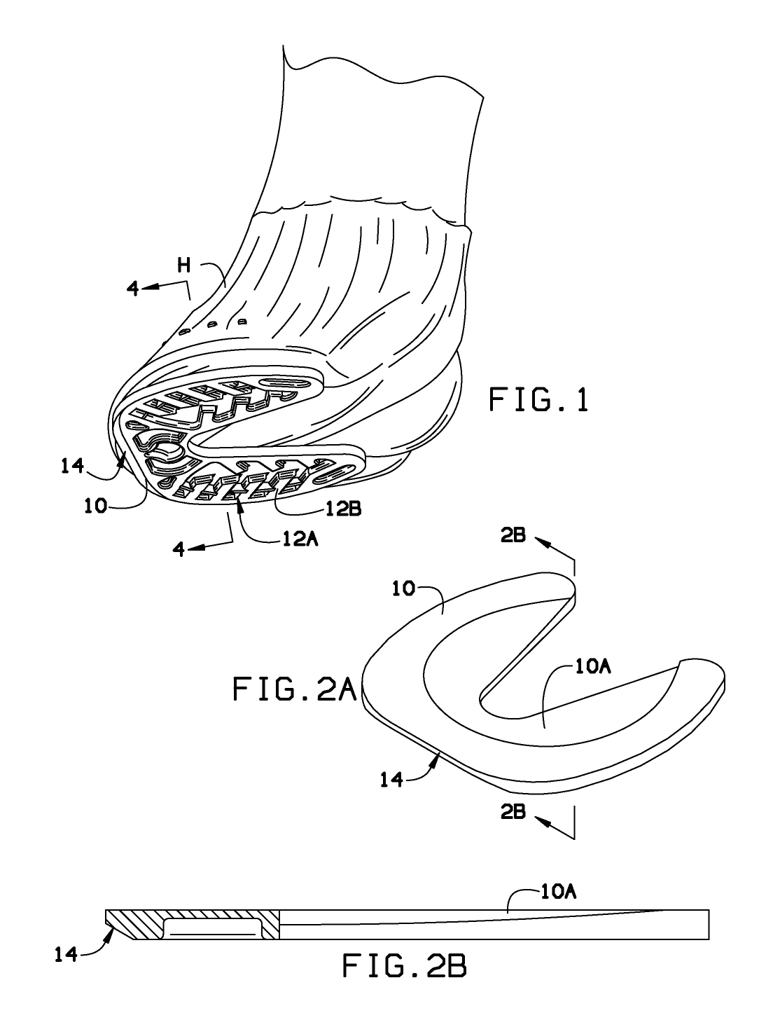

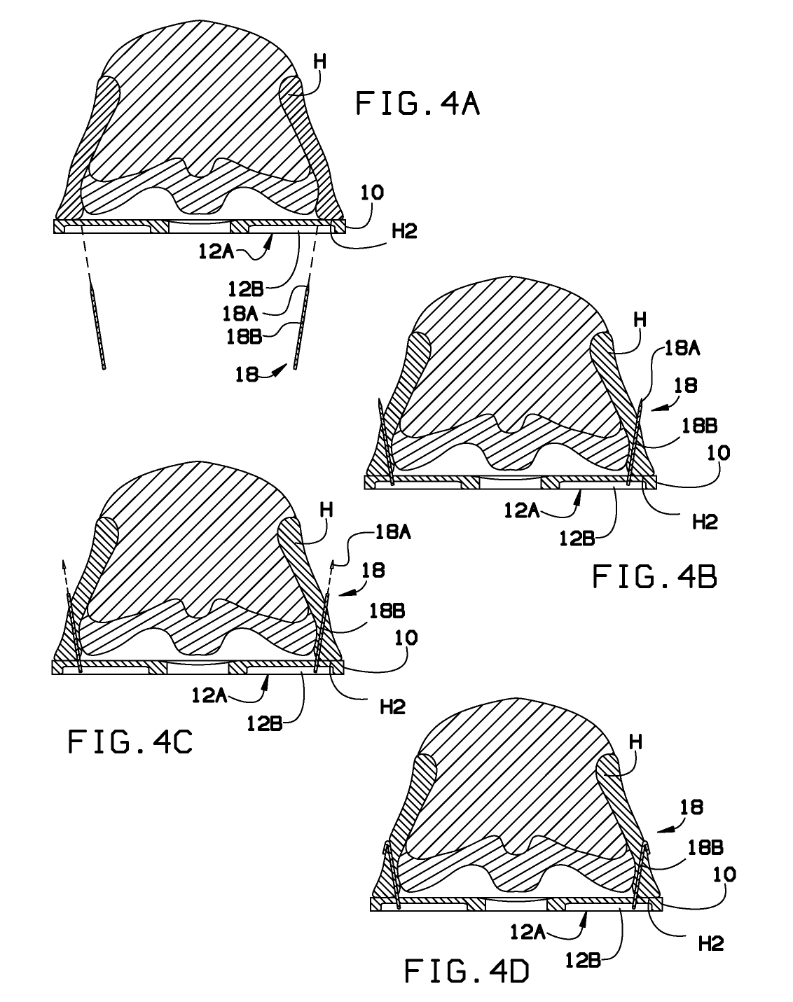

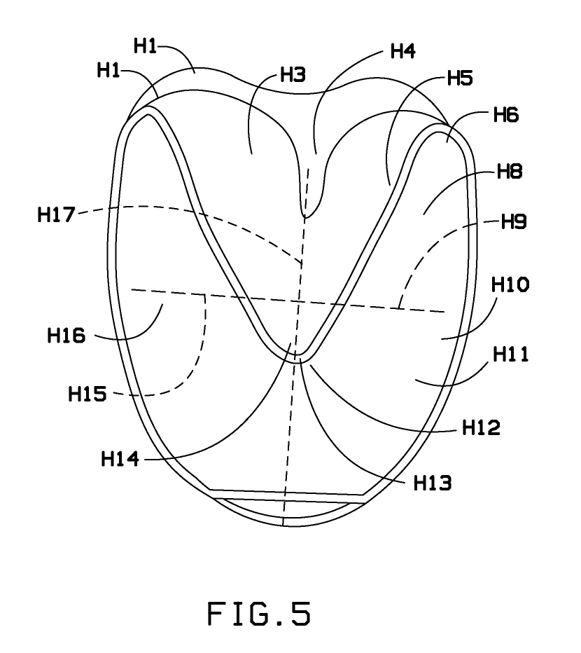

FIG. 1 and FIG. 2A show an embodiment of a horse shoe. The horse shoe comprises top side 10 and bottom side 12. Top side 10 is flat around an outer perimeter and comprises concave portion 10A which slopes inward as the shoe would approach collateral groove H12. The flat outer perimeter allows a nail to perforate top side 10 through the hoof wall as shown in more detail in FIGS. 4A through 4D.

Concave portion 10A aids with shock absorption upon impact with the terrain to reduce shock to the supporting structures of the horse with each stride. Concave portion 10A between the hoof and the outer perimeter maintains hoof slough, (degradation of sole) that is normally lost with ordinary horse shoes. The concave area between the shoe and the sole of the hoof collects small particles of dirt and dust adding to the padded and cushioned effect of the hoof and gives additional direct protection to the coffin bone upon impact between the hoof and the terrain.

This feature adds to the padded effect achieved by the retention of concave portion 10A, aids with additional sole protection in addition to shock absorption on impact for the supporting structures of the horse. Concave portion 10A aids with shock absorption upon impact with the terrain to reduce shock to the supporting structures of the horse with each stride. Concave portion 10A permits flex to allow for additional shock absorption with each stride in contact with the terrain. Concave portion 10A may permit a thin layer of dirt between the sole and the horse shoe to provide additional padding along with sole slough (sole degradation normally lost with current horse shoes) for the absorption of the shock of contact with the terrain. This permits active contact with the hoof and the shoe, thus with the ground and the shoe acts as a protective pad for the sole. This horse shoe provides several millimeters of sole protection in addition to the traction bars between the sole and the terrain to prevent stone bruises. This allows the sole to continue to perform as support for each stride while being protected by the horse shoe.

Topside 10 terminates at front portion 14 which transitions into bottom side 12. Front portion 14 descends downward at an angle to bottom side 12. In some embodiments, the angle of front portion 14 is at least 52 degrees, but preferably 60 degrees. This angle aids the hoof H with each stride to break over more quickly with each stride. The horse shoe is designed with only 5 mm of difference in sizes based upon the width of the horse's foot. The horse shoe is designed to be fitted from the heel buttress H2 forward covering the entire surface upon which hoof H lands for both support and protection. Thus individual sizing for each horse to provides for a short toe and higher heal with angles of 52 degrees and higher to eliminate leverage and injuries to tendons, ligaments and the entire supporting structure from the foot to the spine. The leading edges, the toe of the shoes have a 60 degree angle from the traction area to the contact with hoof H to aid in quicker break over and reduce leverage.

Bottom side 12 comprises a plurality of nail channels 12A and traction bars 12B. Nail channels 12A are angled from the central channel forward toward toe callus H1. There are further channels including a front channel proximate toe callus H1, a front right channel slightly to the right of the front channel and a front left channel slightly left of the front channel. There can be a forward right channel to the right of the front right channel. There can be a forward left channel to the left of the front left channel. In some embodiments, there can be a rear right channel behind the right side channel. In some embodiments, there can be a rear left channel behind the left side channel.

In some embodiments, the horse shoe has ten traction bars providing for twenty edges, whereas prior art horse shoes have only two edges, an inside and an outside. The horse shoe also has twelve nail channels 12B with six nail channels 12B per side. Nail channels 12B are designed to be self-cleaning on landing to purchase dirt and terrain to avoid slipping located on each side of the shoe to provide traction to prevent injury. Prior art horse shoes have little or no traction and many times must have caulks swedges or use borium covered nails to prevent the shoe from slipping. Traction bars 12A and nail channels 12B are configured to force dirt and debris out with each landing thereby has the ability to gain a purchase of terrain to propel the horse with the stride in process without slipping. There is a self-cleaning tread design for traction across the entire hoof capsule. This also aids to deflect potential stone bruising from entry of stones, sticks, and debris into the sole area, to push out mud or debris upon landing and support footing on impact with the terrain, for and during the support period. The angle on the toe of the horse shoe eliminates leverage and reduces the effect of long toe, low heel on all ligaments and tendons connected with the thrust from the hoof up the entire support system to the horse's back.

The traction channels provides fraction across the entire support of the hoof for the thrust to avoid slipping in addition to serving as nail channels for placement of shoes on a damaged foot by allowing the nail to be moved inside the white line area somewhat to accommodate more proper nailing to a damaged foot rather than be placed into a nail hole existing on the outer edge of prior art horse shoes that prevents a nail to be placed because the hoof wall is missing entirely to hold the shoe.

In some embodiments, the overall weight of the 120 mm size horse shoe is slightly over 3 ounces as compared to ordinary aluminum horse shoes of 4 oz. up and steel shoes up to 9-12 ounces per shoe. The horse shoe provides for minimal proportional difference in weight for different sizes of shoes to fit specifically and correctly as needed on larger or smaller horses. When located thirty or more inches from the horses muscle structure providing power for each stride, the leverage difference is much less than with ordinary horse shoes and provides for quickness and speed of movement without the additional weight of ordinary horse shoes thereby reducing the potential for injury to the horse.

The horse shoe is designed to fit hoof H from heel buttress H2, the strongest part of the hoof upon which the horse lands heel first with each stride by providing additional protection and support for the impact. Frog H12 has a rubbery consistency, suggesting its role as shock absorber and grip tool on hard, smooth ground, allows frog H12 to be exposed to perform its normal function within the shock absorption system of hoof H and allows frog H12 to continue as an important part of the blood circulatory system and allows frog H12 to continue to remain hard and calloused to continue its role of protecting hoof H from contact with the terrain. Hoof H and heel buttress H2 flex upon impact and returns to their normal shape ready for the next stride as does the design of the horse shoe flexes and return to its normal shape to prevent bending or breaking Prior art horse shoes do not provide for this and thereby will bend out of shape or break entirely.

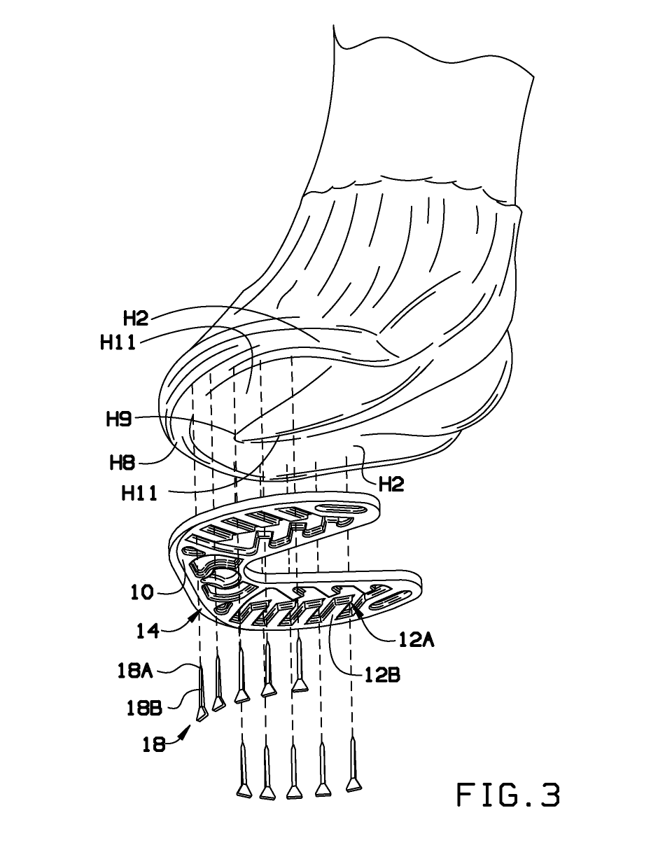

Turning to FIG. 3, horse shoe 10 covers heel bulbs H2, outer hoof horn H8 past waterline H9 and over a portion of the horse's sole H11 as indicated above. Horse shoe 10 is perforate with a plurality of nail holes that can accommodate nails 18. In some embodiments, six left side nails 18 and six right side nails 18 are placed through nail channels 12B and into hoof H. As shown in FIGS. 4A through 4D below.

A user can install the horse shoe as demonstrated in FIGS. 4A through 4D. To install the horse shoe a user can utilize nail 18 which has nail point 18A mechanically coupled to nail body 18B. The user drives nail 18 through nail channel 12B and into hoof. The user then breaks off nail point 18A. The user can then bend nail body 18B over hoof H to secure the horse shoe to hoof H, even if hoof H is damaged. The twelve nail channels 12B on each shoe are designed to allow nail 18 to be moved in toward the center of hoof H or slightly inside white line H11 within nail channel 12B to accommodate a damaged hoof H. To contrast, a prior art horse shoe with pre-punched nail holes would prevent a nail to be placed entirely where no hoof exists.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A horse shoe configured to aid in preventing stone bruise, the horse shoe comprising
a top side is flat around an outer perimeter and comprises a concave portion which slopes inward wherein the outer perimeter can permit a nail to enter a hoof at an angle;
a bottom side connected to the top side through the front portion; and
nail channels and traction bars formed into the bottom side;
wherein the traction bars possess a self-cleaning traction feature that forces dirt and debris from the traction bars enabling the horse shoe to gain traction and avoid excessive slipping.

2. The horse shoe of claim 1, wherein the front portion is angled at 60 degrees.

3. The horse shoe of claim 1, wherein the channels further comprise
a right side central channel which is joined to a plurality of right side connecting channels; and
a left side central channel which is joined to a plurality of left side connecting channels.

4. The horse shoe of claim 1, wherein the channels further comprise
a right side central channel which is joined to a plurality of right side connecting channels; wherein the plurality of right side connecting channels extend from inside and outside of the right side central channel; and
a left side central channel which is joined to a plurality of left side connecting channels; wherein the plurality of left side connecting channels extend from inside and outside of the right side central channel.
